(19) United States
(12) Patent Application Publication
(10) Pub. No.: US 2016/0041932 A1
(43) Pub. Date: Feb. 11, 2016

(54) MEMORY STORAGE WITH BATTERY AND SOLAR CELLS

(71) Applicant: Imation Corp., Oakdale, MN (US)

(72) Inventor: Toshihide Hokari, Woodbury, MN (US)

(21) Appl. No.: 14/456,442

(22) Filed: Aug. 11, 2014

(51) Int. Cl. G06F 13/28; G06F 13/40; G06F 1/26; G06F 13/42

(52) U.S. Cl. CPC G06F 13/28; G06F 13/4221; G06F 13/4027; G06F 1/266

(57) ABSTRACT

A portable storage device can include a memory and one or more connectors for connecting to other devices. During use, a user can connect a remote device such as a smartphone, tablet, or the like to the portable storage device in order to transfer data from the remote device to the memory of the portable storage device. The portable storage device can include a rechargeable power source configured to provide the necessary electrical current for establishing communication between the remote device and the memory of the portable storage device. The portable storage device can further include one or more photovoltaic devices for generating electrical energy and recharging the rechargeable power source of the portable storage device.

### BACKGROUND

Remote devices with multiple functionalities are becoming increasingly popular. For example, a smartphone will often serve not only as a user's cellular phone, but also as the user's photo and video camera and music and video player, in addition to an ever-increasing number of other functions. As the functionality of such devices grows, the demand on the memory storage capacity increases. When the memory of the remote device becomes full, a user must unload digital data from the memory so that he or she can continue to utilize the remote device as intended, for example by capturing images or videos.

Devices for providing portable storage capabilities exist. For example, memory devices can interface with a remote device in order to establish communication between the remote device memory and the memory device memory. In some instances, the communication between such devices requires electrical current, which is typically provided by the remote device acting as a host to the memory device. However, providing the electrical current for such communication can undesirably drain the battery of the remote device.

Additionally, some remote devices are incapable of providing sufficient electrical current to establish such communication. For example, the remote device may have an insufficiently large or insufficiently charged battery for establishing the communication. In some cases, a remote device is prohibited by hardware, software, or some combination thereof, from outputting electricity above a certain threshold. Thus, in such instances, there is a lack of sufficient electrical current to establish communication between the remote device and memory device due to limitations of the remote device.

### SUMMARY

Aspects of the invention are generally related to a portable storage device. A portable storage device can include a memory for storing digital data. The portable storage device can include a first connector connectable to a remote device and capable of providing two-way communication between the memory and the remote device. For example, a smartphone can be connected to the portable storage device via the first connector and digital data can be transferred back and forth between the smartphone and the memory of the portable storage device.

Embodiments of the portable storage device can include a rechargeable power source. The rechargeable power source can provide electrical current to establish the two-way communication between the memory and a remote device. In some further embodiments, the rechargeable power source can be a memory-dedicated power source such that the rechargeable power source provides current only to establish and support two-way communication between a remote device and the memory of the portable storage device. In some alternative embodiments, the rechargeable power source can also provide current to recharge the remote device via the first connector.

The rechargeable power source can be recharged by various processes. For example, in some embodiments, the portable storage device can include one or more photovoltaic devices for generating electrical energy and recharging the rechargeable power source. The portable storage device can additionally or alternatively include a second connector for connecting to an external device such as a PC. The portable storage device can receive current from an external device or other power source via the second connector in order to recharge the rechargeable power source.

In some embodiments, the second connector can be used to provide two-way data communication between the memory of the portable storage device and an external device. In such embodiments, digital data can be removed from the memory of the portable storage device and transferred to the external device. In some embodiments, the functionality of the second connector can be integrated into the first connector such that the portable storage device includes a single connector configured to perform the functionalities of the first and second connectors.

### BRIEF DESCRIPTION OF THE DRAWINGS

FIG. 1A is a view of a representative portable storage device according to some embodiments of the invention.

FIG. 1B is a schematic representation illustrating additional components of the portable storage device of FIG. 1A.

FIG. 2A is a schematic representation of an exemplary portable storage device according to some embodiments of the invention.

FIG. 2B is a schematic representation of an embodiment of a portable storage device including a single connector.

FIGS. 3A-3C are process flow diagrams illustrating exemplary operation of a portable storage device in conjunction with a remote device and an external device.

### DETAILED DESCRIPTION

The following detailed description is exemplary in nature and is not intended to limit the scope, applicability, or configuration of the invention in any way. Rather, the following description provides some practical illustrations for implementing examples of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

Portable storage devices may be used to store digital data and transfer the digital data from device to device. In some configurations, portable storage devices can be configured to interface with one or more remote devices. In general, a remote device is a device that is remote from a traditional central or local computer and can be used to acquire and/or display or otherwise present digital data such as photographs, video and audio to a user. Such remote devices can include, for example, cellular telephones, smartphones, tablets, cameras, displays, music players, recorders, wearable computing devices, and the like. Such remote devices have limited storage capacity which can be entirely allocated over time. For example, a camera or smartphone can be used to acquire digital data such as audio, video or photos, which consume available storage in memory. As memory is consumed, the user may desire to remove some of the digital data from the remote device in order to, for example, clear some of the memory for acquiring more data. Accordingly, the user may transfer digital data from the remote device to the portable storage device in order to preserve the digital data while clearing space in the memory of the remote device. In some examples, a portable storage device is connectable to an external device, such as a computer or other device, for transferring digital data to a larger and/or more permanent location.

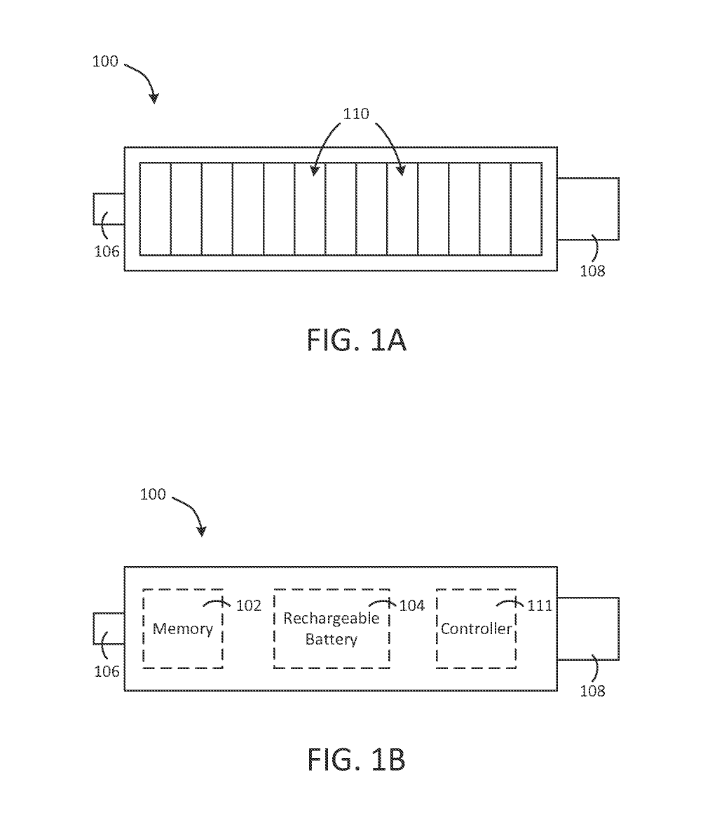

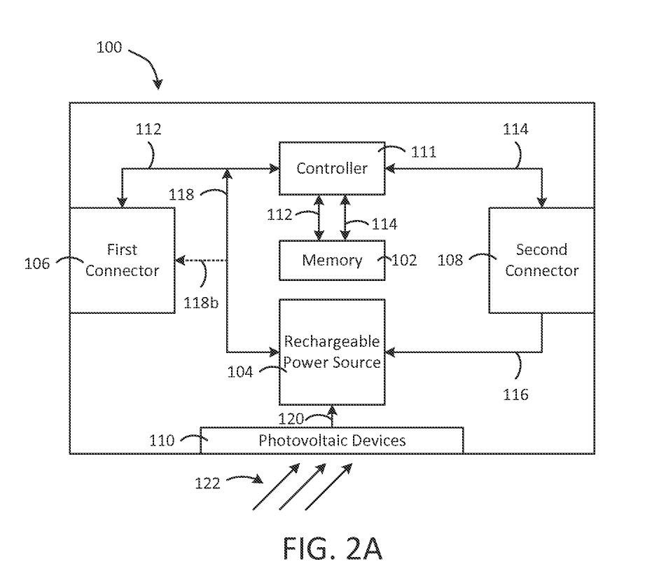

FIG. 1A is a plan view of a portable storage device according to some embodiments of the invention. As shown, the portable storage device 100 includes a first connector 106 and a second connector 108. In some embodiments, first 106 and second 108 connectors can be integrated into a housing of the portable storage device 100. In alternative embodiments, one or both of the first 106 and second 108 connectors can be attached to the housing by a cable electrically tying the connectors and internal components of the portable storage device 100 together. In some embodiments, such a cable can be integrally coupled to the portable storage device 100, or can alternatively be removable therefrom. In some such embodiments, the first 106 and/or second 108 connectors of the portable storage device can be female connectors such that a male-ended cable can interface with the connector for connection to the remote device. However, the invention should not be limited to such. For example, the first 106 and second 108 connectors can alternatively be both male connectors, or one of the connectors 106 or 108 can be a female connector and the other can be a male connector. To this end, the first 106 and second 108 connectors can be configured to connect with other devices directly or via a cable. In various embodiments, first 106 and second 108 connectors can be the same or different connectors.

The first connector 106 can be configured to connect to a remote device for facilitating data transfer therebetween. In some embodiments, the first connector 106 is a particular connector configured to connect to a particular remote device or family of remote devices. Exemplary connectors can include USB, micro-USB, mini-USB, HDMI, MHL, Lightning, 30-pin, serial connectors and any other connectors known in the art. In various embodiments, connectors can be specific or proprietary to a remote device. In many cases, remote devices include a female port for receiving a connector, and accordingly, in some embodiments, the first connector 106 can be a corresponding male connector for connecting to the remote device.

The exemplary portable storage device 100 of FIG. 1A further includes a second connector 108. The second connector can be configured to interface with an external device, such as a computer. The second connector 108 can be configured to facilitate data transfer between the portable storage device 100 and the external device. In general, the second connector 108 can include any connector known in the art. The second connector 108 can be either the same or a different type of connector as the first connector 106. In some embodiments, the second connector 108 can be a common connector for interfacing with most computers, for example a USB connector. In some configurations, the second connector 108 can be additionally or alternatively configured to connect to a second remote device.

FIG. 1B is a schematic diagram illustrating additional components of the portable storage device of FIG. 1A. The portable storage device 100 of FIG. 1B includes a memory 102 for storing digital data. The memory 102 can store data received from a remote device via first connector 106 or from the second connector 108. Memory 102 can include flash technology, hard drive technology, or other storage technologies known in the art. In some embodiments, flash memory is used to minimize the physical size required for the portable storage device. Accordingly, some portable storage devices include flash memory 102 in sizes of, for example, 16, 32, 64, 128, 256 or 512 GB, or 1 TB. In some embodiments, portable storage device 100 can involve dedicated, built-in memory 102. Device 100 can alternatively or additionally receive or involve removable memory 102, such as an SD or microSD card. Removable memory 102 can allow the user to provide an appropriate amount of memory for the portable storage device in accordance with the user's desired capacity and cost. To facilitate removable memory 102, the portable storage device 100 can include a slot or receptacle for receiving removable memory 102. A user can insert or remove memory 102 into or from receptacle. Thus, in some embodiments, the memory 102 of the portable storage device 100 is of a variable size, wherein the user can insert memory 102 of any desirable size and can exchange one size memory for another. In general, memory 102 can be configured to receive and store digital data from a remote device.

The portable storage device 100 of FIG. 1B further includes a controller 111. In some embodiments, the controller 111 can interface with the memory to read, write and erase data. The controller 111 can format memory 102, for example, creating a memory directory, mapping out bad cells, or perform other known memory formatting processes In some embodiments, the controller 111 can manage wear-leveling in the memory wherein the controller 111 determines which cells within the memory 102 are utilized for data storage. In doing so, the controller 111 can utilize different cells for storing digital data within the memory 102 so that some cells are not used much more frequently than others.

Establishing communication between the remote device and the portable storage device for transferring digital data can require electrical current. In some situations, an electrical current between approximately 40 and 70 milliamps (mA) is required to establish the communication interface. In some instances, the remote device is configured to provide the required electrical current for establishing the communication. However, in other instances, the remote device is incapable of providing such power. For example, a remote device might have an output limitation, from which the remote device can only output a certain level of current or electrical current. In other situations, the remote device may have insufficient energy or charge available to establish the communication, or the remote device might detect that the required power would place too large of an electrical load on the remote device's battery. In any such circumstance, the remote device may be unable to provide the requisite electrical current for establishing communication between the remote device and the portable storage device for data transfer.

Accordingly, the portable storage device 100 of FIG. 1B includes a rechargeable power source 104. Rechargeable power source 104 can provide electrical current required to establish the communication between the memory 102 of the portable storage device with the remote device. In various embodiments, the rechargeable power source 104 can include any appropriate rechargeable technology, such as Lithium Ion batteries, Lithium Polymer batteries, Nickel Metal Hydride batteries, capacitive storage devices, or other known rechargeable technologies. In some embodiments, the rechargeable power source 104 can store approximately 100 milliamp-hours (mAh) of charge. Various embodiments can be configured to include a rechargeable power source 104 with a wide variety of storage capacities. Embodiments can include power sources with charge storage capacities ranging from approximately 10 mAh to upwards of approximately 10 Ah. The upper parameter of this range can, in some examples, be based on the physical size of the rechargeable power source 104. The rechargeable power source 104 of the portable storage device 100 enables the transfer of data from a remote device to the memory 102 of the portable storage device 100 even if the remote device is unable to or incapable of providing the necessary electrical current to do so.

Providing electrical current from the rechargeable power source 104 to enable communication between the remote device and the portable storage device 100 will draw stored charge from the rechargeable power source 104. Eventually, the useable charge in the rechargeable power source 104 will be depleted. In some embodiments, the second connector 108 can provide charge to the rechargeable power source 104. For example, the second connector 108 can include a standard USB connector for connecting to a computer or other USB-interfaced power source. In some such embodiments, the portable storage device 100 can be plugged in to a USB receptacle via the second connector 108 to receive electrical current which can be used to recharge the rechargeable power source 104. In general, any known charging mechanism can be used for providing electrical current to recharge the rechargeable power source 104. For example, in some embodiments, the portable storage device 100 includes a connector for connecting directly to a generic power receptacle such as a wall socket for providing electrical current to the rechargeable power source 104 of the portable storage device 100.

With reference back to FIG. 1A, embodiments of the invention can include one or more photovoltaic devices 110 for receiving optical energy and producing electrical energy. The electrical energy produced by photovoltaic devices 110 can be used to recharge the rechargeable power source 104 by providing electrical current to the rechargeable power source 104. In various embodiments, one or more photovoltaic devices 110 can include a single-cell device, or a plurality of photovoltaic cells arranged in series or parallel. Photovoltaic devices 110 can include any known appropriate photovoltaic material for producing electrical energy such as silicon or other semiconductor materials. In some embodiments, the photovoltaic devices can include silicon, such as amorphous silicon, polycrystalline silicon, or monocrystalline silicon, for example. The one or more photovoltaic devices 110 can be positioned on one or more exterior surfaces of the portable storage device 100. Thus, when light is incident on the one or more exterior surfaces of the portable storage device 100 including one or more photovoltaic devices 110, the photovoltaic devices 110 can recharge the rechargeable power source 104 by providing electrical current thereto.

In some instances, a remote device is capable of providing more than the necessary amount of electrical current for enabling communication between the remote device and the portable storage device 100. In some such instances, the excess current available from the remote device can be directed toward the rechargeable power source 104. Accordingly, in some embodiments, a remote device can provide electrical current to recharge the rechargeable power source 104 via the first connector 106. For example, the first connector 106 can include a standard micro USB connector for connecting to a remote device or other micro-USB-interfaced power source that is configured to provide more than the required electrical current for establishing the communication. In some embodiments, providing electrical current from the remote device to the rechargeable power source 104 is controlled by a processor, for example on the remote device, for example an application (app) on a smartphone. In some such embodiments, the remote device can recognize its ability to output more current than is necessary for establishing communication and accordingly directs the remaining available output current toward the rechargeable power source 104.

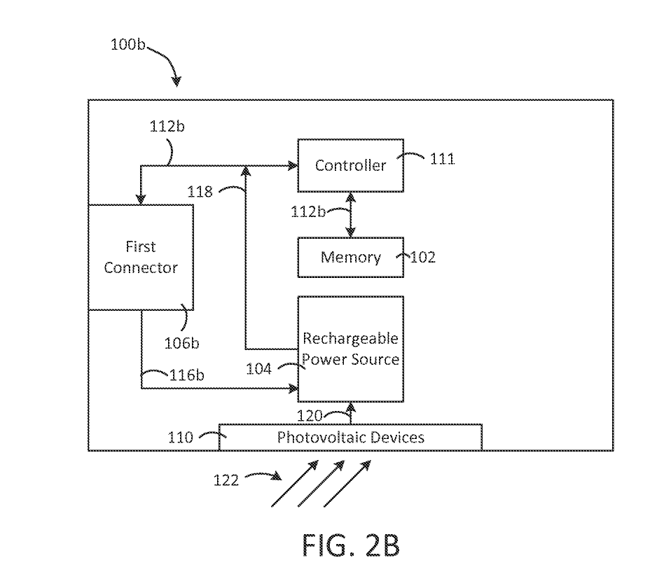

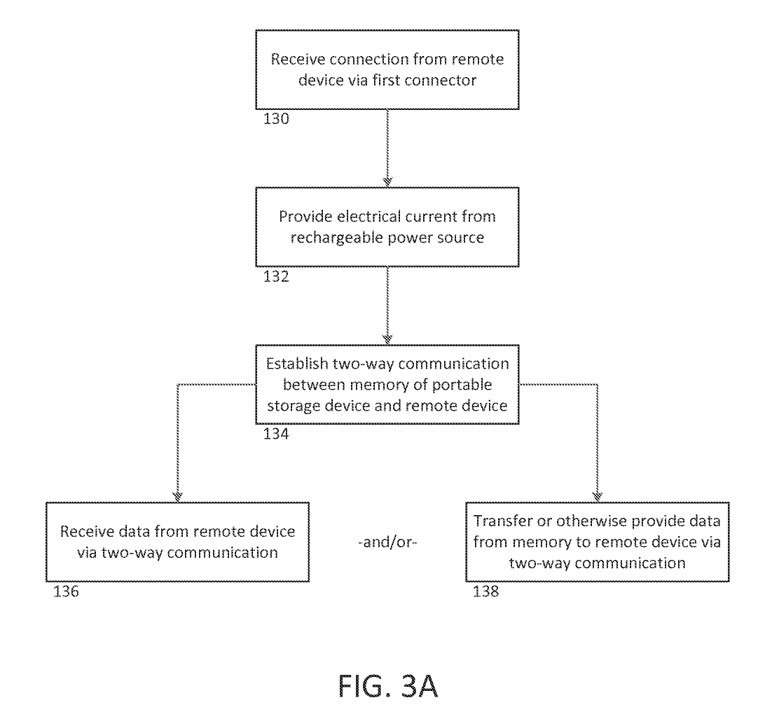

FIG. 2A is a schematic diagram of an exemplary portable storage device according to some embodiments of the invention. Device 100 includes a memory 102, a rechargeable power source 104, a first connector 106 and a second connector 108. In general, the first connector 106 is configured to conform to a first connector standard, while the second connector 108 is configured to conform to a second connector standard. First and second connector standards can be dependent on the devices with which first 106 and second 108 connectors are intended to interface.

As shown, the portable storage device 100 includes a memory 102 in two-way communication 112 with the first connector 106 via a controller 111 such as those discussed with respect to FIG. 1B. A remote device can be connected to the portable storage device 100 via the first connector 106 and thereby interface with memory 102 via two-way communication 112 to facilitate the transfer of digital data between the portable storage device 100 and the remote device. That is, two-way communication 112 can be used to send data from the remote device to memory 102 or to retrieve data from memory 102 to send to the remote device. As shown, two-way communication 112 passes through controller 111 such that, in some embodiments, the controller 111 can control where and how digital data received from the first connector 106 is stored in or accessed from memory 102.

In some examples, a user can choose to copy digital data from the remote device to the memory 102 of the portable storage device 100 to back up the data, or to move the data from the remote device to memory 102 to clear space on the remote device. Thus, as used herein, transferring data means moving or copying data from one location to another. In addition, the user can choose to upload digital data from the memory 102 of the portable storage device to the remote device, or to access digital data stored in memory 102 on the remote device for playback, for example, without transferring the data to the memory of the remote device. Thus, two-way communication 112 allows a user to move data back and forth between a remote device and the memory 102 of the portable storage device, and, in some embodiments, access digital data stored in memory 102 with the remote device, by way of the first connector 106.

As described above, in some instances, providing communication such as two-way communication 112 between the first connector 106 (or a remote device attached to the first connector 106) and memory 102 requires electrical current for enabling communication. Accordingly, in the illustrated embodiment, rechargeable power source 104 is configured to provide the required electrical current to establish two-way communication 112 by electrical connection 118. Electrical connection 118 can provide the required electrical current to enable two-way communication 112 between a remote device and the memory 102 of the portable storage device 100 in the event that the remote device does not or cannot provide such electrical current.

In some embodiments, the rechargeable power source 104 is configured to provide electrical current exclusively for enabling two-way communication 112 between the first connector 106 and memory 102. In such embodiments, rechargeable power source 104 may be referred to as a memory-dedicated rechargeable power source 104. In alternative embodiments, the rechargeable power source 104 can additionally or alternatively provide electrical current to the remote device from the first connector 106 via connection 118b. In some such embodiments, the rechargeable power source 104 can provide electrical current to enable two-way communication 112 between the first connector 106 and memory 102 and to the remote device via 118b simultaneously.

In the illustrated embodiment, the portable storage device 100 includes a second connector 108. The second connector 108 as shown is in two-way communication 114 with memory 102. Two-way communication 114 can allow for data transfer from an external device such as a computer to memory 102 of the portable storage device 100 for portable storage of the data, or from the memory 102 of the portable storage device 100 to the external device to clear space in the memory 102 for receiving more data. In some embodiments, two-way communication 114 passes through the controller 111 as described above with respect to two-way communication 112. Thus, the controller 111 can control parameters regarding where and how data is stored in or accessed from memory 102. While not shown in the illustrated schematic, in some embodiments, if the second connector 108 or external device is such that the electrical current available to draw therefrom is insufficient to establish or support two-way communication 114, rechargeable power source 104 can provide the power for such communication as discussed above with regard to electrical connection 118. In some instances, the external device can provide the required electrical current for enabling two-way communication 114. The second connector 108 can further provide electrical current to recharge the rechargeable power source 104 via electrical connection 116.

In some embodiments, the functionality of the second connector can be integrated into the first connector, allowing for the first connector to connect to an external device as well as a remote device. FIG. 2B illustrates an exemplary embodiment of a portable storage device including a single connector. In FIG. 2B, the portable storage device 100b includes a first connector 106b for interfacing with a remote device as described above, allowing the transfer of digital data to or from a remote device from memory 102 via two-way communication 112b. However, in the illustrated embodiment of FIG. 1B, the first connector 106b is in communication with the rechargeable power source 104 via electrical connection 116b so that electrical current can be supplied to the rechargeable power source 104 via the first connector 106b.

Accordingly, in such an embodiment, the first connector 106b can provide the combined functionality of the first 106 and second 108 connectors of FIG. 2A. For example, the first connector 106b can provide two-way communication 112b between the memory 102 of the portable storage device 100/100b and either a remote or an external device. As shown, and similarly to two-way communication 112 and 114 of FIG. 2A, in some embodiments two-way communication 112b can pass through controller 111 which dictates where and/or how digital data is stored in memory 102, or where data is accessed from. The first connector 106b can also be used provide electrical current from an external device to recharge the rechargeable power source 104 via electrical connection 116b.

The portable storage device 100 of FIG. 2A and the portable storage device 100b of FIG. 2B include one or more photovoltaic devices as described previously. One or more photovoltaic devices 110 can receive light energy 122 and convert it into electrical energy. The electrical energy generated by the one or more photovoltaic devices 110 can be directed to the rechargeable power source 104 by electrical connection 120. Electrical energy provided by the one or more photovoltaic devices 110 can be used to recharge the rechargeable power source 104 as its charge is depleted through use. In some embodiments, the one or more photovoltaic devices 110 provide on the order of microamps (μA) of current to the rechargeable power source 104 via electrical connection 120. In contrast to recharging the rechargeable power source 104 via the first 106 or the second 108 connectors, recharging the rechargeable power source 104 by the one or more photovoltaic devices 110 does not require the portable storage device 100 to be connected to an external or remote device. Rather, the one or more photovoltaic devices 110 need only receive light energy to generate electricity for charging the rechargeable power source 104. In this way, the rechargeable power source 104 can be conveniently charged anywhere there is sufficient light energy incident on the one or more photovoltaic devices 110.

During an exemplary use, a user operates a remote device, such as a smartphone, to acquire digital data. Data can involve, for example, audio, video, or image data captured by the user using the remote device. With use, the memory of the remote device becomes full. A user can connect the remote device to the portable storage device via the first connector 106 and move digital data from the internal memory of the remote device to the memory 102 of the portable storage device via two-way communication 112 in order to clear space for acquiring more digital data. Thus, the user can use the portable storage device 100 to clear space on the remote device, thereby increasing its available memory.

Once data has been transferred to the portable storage device 100, it can subsequently be transferred to another device or otherwise utilized while in memory 102 of the portable storage device 100. In some embodiments, after data has been moved from a first remote device to the memory 102, a user can connect a second remote device to the first connector 106 and transfer the digital data from memory 102 to the second remote device, utilizing the portable storage device to facilitate the transfer of digital data between separate remote devices. A user can also connect the remote device to the portable storage device in order to transfer data from the portable storage device to the remote device, or to access data stored in the memory 102 of the portable storage device for use with the remote device. For example, a user can connect a smartphone to the portable storage device and play a video file on the smartphone that is located on memory 102 in portable storage device.

In some embodiments, when connected, the remote device and portable storage device adopt a ‘host/device’ relationship. That is, the remote device (host) controls the operation of the portable storage device (device). During operation, a user controls two-way data transfer between the remote device and the portable storage device via the remote device. However, in some instances, the remote device is incapable of performing host capabilities, and, in some cases, cannot provide the necessary electrical current to establish two-way communication between the remote device and the portable storage device. In some such configurations, the portable storage device is configured to not only provide the necessary current for supporting the communication, but can become the effective ‘host,’ for example via an internal processing unit (e.g., a microprocessor). For example, the internal processing unit can govern the transfer of data between a remote device and the memory 102 of the portable storage device 100 via connection 112. In some examples, the internal processing unit can similarly act as a host for facilitating communication 114 between the memory 102 and an external device.

In some embodiments, though the host functionality is a part of the portable storage device 100, data transfer can be facilitated through a user interface on the remote device. In some configurations, such as in the case of some smartphones or tablets, for example, the user can install an application or other software on the remote device that allows data transfer control from the device (i.e., the remote device) as opposed to the host (i.e., the portable storage device). In other embodiments, such control capability and/or software is available on the remote device by default. In either case, in such embodiments, the user can initiate the transfer of data in either direction between the two devices via the remote device.

Through use, the memory 102 in the portable storage device may become full. In some embodiments, the portable storage device can involve a second connector 108 for connecting to an external device. In some embodiments, the second connector 108 involves a male USB connector, and the external device involves a computer. The external device can connect to the second connector 108 and provide two-way communication 114 between the portable storage device and the external device. Thus, the user can initiate two-way data transfer between the portable storage device and the external device, enabling the clearing of memory 102 to provide available storage in the portable storage device. In some embodiments, the interface between the portable storage device and the external device adopts a similar host/device relationship as described above, in which data transfer is controlled via the external device. Additionally, in some embodiments, the charging of the rechargeable power source 104 via the second connector 108 can be initiated by the user via the external device, or can be performed automatically.

Another side effect of use is that, as the rechargeable power source 104 powers two-way communication 112 between a remote device and memory 102, the rechargeable power source 104 becomes depleted of charge. However, in some embodiments, one or more photovoltaic devices 110 disposed on an exterior surface of the portable storage device 100 can provide electrical current to the rechargeable power source 104, allowing it to at least partially recharge. Additionally, in further embodiments, a user can connect the portable storage device 100 to an external device via the second connector 108 (or in some embodiments, first connector 106b as in FIG. 2B). The external device can provide charge to the rechargeable power source 104 via electrical connection 116/116b to recharge the portable storage device 100.

In some examples, user-initiated recharging of the rechargeable power source 104 via the second connector 108 recharges the power source 104 more quickly than the one or more photovoltaic devices. Accordingly, during exemplary operation over time, a user can utilize the portable storage device 100 to interface with one or more remote devices via two-way communication 112. The rechargeable power source 104 can provide electrical current to enable two-way communication 112 when the remote device cannot provide the necessary electrical current. The one or more photovoltaic devices 110 can restore some of the charge lost from the rechargeable power source 104, however, with continued use, the available charge can continue to decrease. Eventually, the user may need to connect the portable storage device 100 to an external device, which provides electrical current to the rechargeable power source 104 via electrical connection 116/116b.

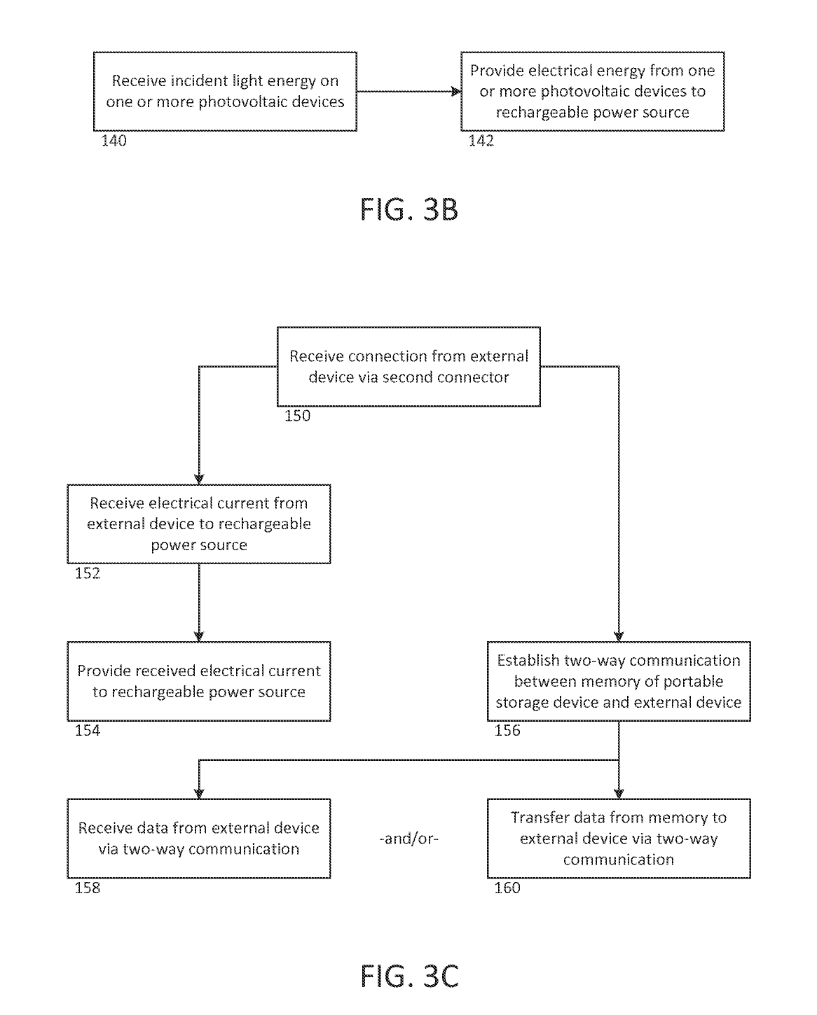

FIGS. 3A-3C are process flow diagrams illustrating exemplary operation of a portable storage device in conjunction with a remote device and an external device. With regard to FIG. 3A, in step 130 the portable storage device can receive a connection from a remote device via a first connector. For example, the portable storage device can be plugged into the remote device or the two can be connected by an interface cable. In step 132, the portable storage device can provide electrical current from a rechargeable power source to the connection between the portable storage device and the remote device. Providing electrical current can establish two-way communication between memory of the portable storage device and the remote device in step 134. For example, in some instances the remote device cannot provide the necessary electrical current for establishing such communication. Once two-way communication has been established in step 132, the portable storage device can receive data from the remote device in step 136 and/or transfer or otherwise provide data from memory to the remote device via two-way connection in step 138. Thus, the portable storage device can be used to clear space in the memory of the external device, and/or allow the remote device to access and utilize data from the portable storage device without it consuming memory in the remote device.

As described, providing electrical current from the rechargeable power source, such as in step 132 of FIG. 3A, can deplete the rechargeable power source of charge. FIGS. 3B and 3C are process flow diagrams including methods for recharging the rechargeable power source. For example, with reference to FIG. 3B, the portable storage device receives incident light energy on one or more photovoltaic devices in step 140. The one or more photovoltaic devices can be located, for example, on one or more exterior surfaces of the portable storage device. The one or more photovoltaic devices can generate electricity from the incident light energy. Accordingly, the portable storage device provides electrical energy from the one or more photovoltaic devices to the rechargeable power source in step 142. This can act to at least partially recharge the rechargeable power source, extending the operating life of the rechargeable power source without the need of actively connecting the portable storage device to an external charging device.

With reference to FIG. 3C, in step 150, the portable storage device receives a connection from an external device via a second connector (or the first connector as in FIG. 2B). The portable storage device can receive electrical energy from the external device, and in step 154 subsequently provides some or all of the received electrical energy to the rechargeable power source. Accordingly, the rechargeable power source can be recharged by the external device via the second connector. In step 156, the portable storage device establishes two-way communication between the memory and the external device. In some embodiments, such two-way communication can be established by the external device operating as a host, while in other embodiments, the communication is established by the portable storage device, for example in a USB-OTG mode. Once two-way communication is established, the portable storage device receives data from the external device in step 158, and/or transfers data from memory to the external device in step 160. Accordingly, the portable storage device can receive data from the external device for future use with, for example, a remote device. The portable storage device can also transfer data to the external device, clearing space in memory for receiving more data in the future. Thus, by interfacing with an external device via the second connector, the portable storage device can receive electrical energy to recharge the rechargeable power source and transfer data to the external device to clear room in memory.

It will be appreciated that the process-flow diagrams of FIGS. 3A-3C are exemplary, and that various steps may be permuted or omitted according to various embodiments of the invention. In some embodiments, one or more steps in the illustrated processes may be initiated by a user via a remote device or an external device. For example, a user may initiate data transfer between the portable storage device and (i) a remote device or (ii) an external device. In other embodiments, data transfer can be initiated automatically when two-way communication is established.

In some configurations, if both a remote device and an external device are connected to the portable storage device via the first and second connectors, respectively, processes such as illustrated in FIGS. 3A or 3C can be performed. In other embodiments, the portable storage device will only operably communicate with one of the simultaneously-connected remote and external devices. In various examples, either a remote device or an external device will always take precedence over the other. In other examples, whichever device was connected to the portable storage device first will be operable. In still further embodiments, whichever device was most recently connected to the portable storage device will be operable.

In an exemplary method of use, a user can connect a remote device to the portable storage device and transfer data from the remote device to the portable storage device. When use of the portable storage device with the remote device is complete, the user can disconnect the remote device from the portable storage device. Doing so can terminate the connection between the remote device and the portable storage device, enabling communication with another remote device or, in some embodiments, an external device.

Various examples have been described. In some embodiments, the portable storage device can include a plurality of connectors for connecting to various remote devices. The plurality of connectors can include like or different connectors or any combination thereof. A user of any connected remote device can control data flow between the memory in the portable storage device and any attached remote device in a host/device configuration. In some cases, the portable storage device can act as an intermediary between simultaneously connected remote devices, allowing data to be transferred therebetween. Embodiments described herein are exemplary in nature and do not limit the scope of the invention.

1. A portable storage device comprising:
a memory;
a rechargeable power source;
a first connector connectable to a remote device and capable of providing two-way communication between the memory of the portable storage device and the remote device; and
a second connector connectable to an external device and capable of providing two-way data transfer between the memory of the portable storage device and the external device and electrical current from the external device to the rechargeable power source of the portable storage device; wherein
the rechargeable power source provides electrical current to establish two-way communication between the memory of the portable storage device and the remote device when the remote device is connected to the portable storage device via the first connector.

2. The portable storage device of claim 1, further comprising one or more photovoltaic devices electrically coupled to the rechargeable power source, wherein the one or more photovoltaic devices provide electrical energy to the rechargeable power source when light is incident on the one or more photovoltaic devices.

3. The portable storage device of claim 2, wherein the memory comprises flash memory or a hard drive.

4. The portable storage device of claim 2, further comprising a controller to manage the data stored in the memory.

5. The portable storage device of claim 4, wherein the first connector is one of: a USB, micro-USB, mini-USB, HDMI, MHL, Lightning, 30-pin, and serial connector.

6. The portable storage device of claim 2, wherein the memory comprises removable memory.

7. The portable storage device of claim 2, wherein the memory size is one of: 16, 32, 64, 128, 256 or 512 GB, or 1 TB.

8. The portable storage device of claim 2, wherein the first connector is further configured to provide electrical current from the remote device to the rechargeable power source of the portable storage device.

9. The portable storage device of claim 2, wherein the remote device is a smartphone or a tablet.

10. The portable storage device of claim 2, wherein the remote device can playback information stored on the memory of the portable storage device.

11. The portable storage device of claim 2, wherein the remote device controls the transfer of data between the portable storage device and the remote device.

12. The portable storage device of claim 2, wherein the rechargeable power source comprises a memory-dedicated rechargeable power source, wherein the rechargeable power source is configured to provide electrical current only to enable two-way communication between the memory of the portable storage device and the remote device.

13. The portable storage device of claim 2, wherein the one or more photovoltaic devices comprises amorphous silicon.

14. A method comprising:
receiving a connection from a remote device via a first connector
providing electrical current from a rechargeable power source to establish two-way communication between a memory and the remote device;
receiving light energy via one or more photovoltaic devices;
generating electrical energy from the received light energy via the one or more photovoltaic devices; and
providing the generated electrical energy from the one or more photovoltaic devices to the rechargeable power source.

15. The method of claim 14, further comprising receiving digital data from the remote device via the two-way communication and the first connector; and
storing the received digital data in the memory.

16. The method of claim 14, further comprising
receiving a connection with an external device via a second connector;
receiving electrical energy from the external device via the second connector; and
charging the rechargeable power source from the received electrical energy.

17. The method of claim 16, further comprising transferring data from the memory to the external device.

18. The method of claim 16, further comprising terminating the connection with the remote device prior to receiving the connection with the external device via the second connector.

19. A portable storage device comprising:
a memory;
a memory-dedicated rechargeable power source;
one or more photovoltaic devices electrically coupled to the memory-dedicated rechargeable power source; and
a first connector connectable to a remote device and capable of providing two-way communication between the memory of the portable storage device and the remote device; wherein
the memory-dedicated rechargeable power source provides electrical current to establish communication between the memory of the portable storage device and the remote device when the remote device is connected to the portable storage device via the first connector; and
the one or more photovoltaic devices provides electrical current to the memory-dedicated rechargeable power source when light is incident on the one or more photovoltaic devices.

20. The portable storage device of claim 19, further comprising a second connector, the second connector connectable to an external device such that the portable storage device can:
(i) receive electrical energy from the external device via the second connector; and
(ii) transfer data from the memory to the external device via the second connector.
